(19) United States
(12) Patent Application Publication
(10) Pub. No.: US 2008/0002972 A1
(43) Pub. Date: Jan. 3, 2008

(54) All Order Polarization Mode Dispersion Compensation with Spectral Interference Based Pulse Shaping

(75) Inventors: Arthur Dogariu, Hamilton, NJ (US); Philip Nan Ji, Plainsboro, NJ (US); Ting Wang, Princeton, NJ (US); Yutaka Yano, Tokyo (JP); Tsutomu Tajima, Tokyo (JP)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 11/762,850

(22) Filed: Jun. 14, 2007

Related U.S. Application Data
(60) Provisional application No. 60/804,668, filed on Jun. 14, 2006.

(51) Int. Cl. H04B 10/08; H04B 17/00

(52) U.S. Cl. 398/25

(57) ABSTRACT

A method includes determining spectral interference in real time on an optical signal by an optical path, the spectral interference being indicative of polarization mode dispersion by the optical path, and imposing optical pulses with a phase opposite to the spectral interference on the optical signal. Preferably, the imposing step comprises altering the amplitude or phase of a signal indicative of the spectral interference with an active element. The active element is preferably an acousto-optic modulator.

This application claims the benefit of U.S. Provisional Application No. 60/804,668, entitled “All Order PMD Compensation Using Spectral Interference and Pulse Shaping”, filed on Jun. 14, 2006, the contents of which is incorporated by reference herein.

### BACKGROUND OF THE INVENTION

The present invention relates generally to optical communications, and, more particularly, to all order polarization mode dispersion compensation using spectral interference and pulse shaping.

Polarization mode dispersion (PMD) is an optical phenomenon that affects signal quality during optical transmission. During transmission in standard optical fibers, the optical signal undergoes changes in polarization due to uncontrollable physical changes in the optical fiber. Because light travels at slightly different velocities for different polarizations, the pulse shape is broadened over time and distorted. This pulse broadening phenomena is referred to as the PMD. Quantitatively, PMD is defined as the wavelength-averaged value of the differential group delay (DGD) between the propagation times at two orthogonal axes (planes) for the polarization.

PMD is usually caused by environmental conditions such as physical stress, temperature variation and fiber imperfections. It is dynamic and varies over time. The individual factors that cause PMD cannot be measured or even observed in isolation, the phenomenon must be viewed as a constantly changing, unstable stochastic process. There are no known practical ways of eliminating its effects entirely.

At lower bit rate transmissions, PMD is not an important factor and is often neglected. However as the transport speed increases above 10 Gb/s, particularly at 40 Gb/s and 160 Gb/s, the impairment from PMD becomes a serious issue due to the short bit period and it limits the transmission distance. At these high bit rates, higher order PMDs (such as the second-order PMD, which is the variation of first order PMD with wavelength/frequency) also become important factors in system degradation. As the demand of network traffic bandwidth grows and DWDM network transmission bit rate increases, compensation for first order and higher order PMD has attracted strong research interests.

In recent years a variety of schemes have been proposed to counter the effect of PMD. Electronic dispersion compensation (EDC) can be used successfully to compensate for pulse distortion caused by many factors, including PMD, but EDC cannot handle high transmission rates when the bandwidth becomes large. In order to deal with PMD at high rates, some type of hardware compensation techniques have to be employed and are currently under investigation. Many compensating schemes are based on feedback loops and complex algorithms to optimize the control parameters. These schemes have the advantage that they do not require the knowledge of the PMD parameters. They are based on monitoring the degree of polarization and, using a feedback loop, changing the state of polarization in order to minimize an error signal. However, they are cumbersome and less practical for fast live compensation, because their algorithms rely on random guesses and iterative loops. More promising schemes are based on feed forward compensators, because they are faster and easier to implement. However, they require the knowledge of the fiber's PMD parameters at any given time. Measuring the state of polarization (SOP) and then using dispersive elements to compensate for PMD has been considered, but measuring SOP can prove to be difficult and time consuming, making a challenge for using these devices for live compensation.

Accordingly, there is a need for practical technique for fast and live compensation for polarization mode dispersion in high bit rate transmissions.

### SUMMARY OF THE INVENTION

In accordance with the invention, a method includes determining spectral interference in real time on an optical signal by an optical path, the spectral interference being indicative of polarization mode dispersion by the optical path, and imposing optical pulses with a phase opposite to the spectral interference on the optical signal. Preferably, the imposing step includes altering the amplitude or phase of a signal indicative of the spectral interference with an active element such as acousto-optic modulator.

In another aspect of the invention, a method includes compensating for distortion by an optical path on an optical signal by imposing a real time phase spectrum opposing the spectral interference indicative of the distortion by the optical path. In a preferred embodiment, the real time phase spectrum opposing the spectral interference is provided by a pulse shaper employing active amplitude or active phase changing at each frequency component of the spectral interference.

In yet another aspect of the invention, an apparatus includes a pulse shaper in an optical path for imposing an opposing optical signal for compensating for distortion by the optical path, and a feed forward loop for determining phase spectrum of the distortion in real time for influencing the pulse shaper. Preferably, the pulse shaper includes an acousto-optic modulator for varying a phase or amplitude of a signal in accordance with the phase spectrum of the distortion.

### BRIEF DESCRIPTION OF DRAWINGS

These and other advantages of the invention will be apparent to those of ordinary skill in the art by reference to the following detailed description and the accompanying drawings.

FIG. 1 illustrates the random birefringent fiber as a stack of randomly oriented waveplates;

FIG. 2 is a schematic showing a Mach-Zender Interferometer to illustrate the phases along x and y that lead to spectral modulation due to interference;

FIG. 3 is a graph showing the spectral interference obtained from a Mach-Zender interferometer;

FIG. 4 is a schematic of a pulse shaper with AOM in a 4-f geometry;

FIG. 5 is a schematic of an all-order compensator using feed-forward pulse shaper, in accordance with the invention;

FIG. 6 is a schematic of an alternate embodiment of an all order PMD compensation scheme, in accordance with the invention;

FIG. 7 depicts spectral interference patterns with 0, 10, 20, 30 and 40 picoseconds PMD delays;

FIG. 8 depicts linear phase as a function of first order PMD;

FIG. 9 depicts the spectrum of a wave unaffected by pulse shaping; and

FIG. 10 shows various examples of spectrum manipulation via pulse shaping on the wave shown in FIG. 9.

### DETAILED DESCRIPTION

The inventive method of compensating for polarization mode dispersion PMD is based on a live measurement of the polarization dispersion using spectral interference, and compensation for the dispersion using pulse shaping.

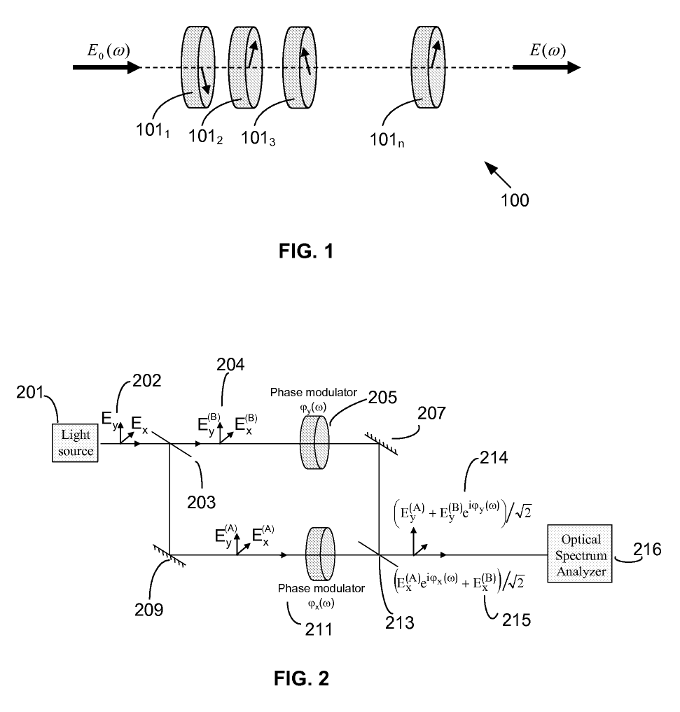

Referring to FIG. 1, there is shown a theoretical model 100 for polarization mode dispersion. When considering the propagation through single-mode fibers, although they are supposed to be single mode, in practice the optical fibers are anisotropic and support two modes of propagation distinguished by polarization. Because of the optical birefringence, the two modes travel with different group velocities. The random change of the birefringence leads to a random coupling between the modes. This is the basis of PMD, which results in pulse distortion and limits the transmission capacity of the optical fiber. It is useful for understanding the invention to consider the optical fiber as a series of successive optical waveplates 101₁, 101₂, 101₃ through 101ₙ with their principal axis rotated one from another. At any given moment the waveplates have random orientation. Furthermore, they change their orientation on sub-millisecond time scale, mostly due to environmental changes such as temperature, stress, vibrations, etc.

From the birefringence point of view, the fiber can be considered as a stack of the N waveplates 101₁₋ₙ as shown in FIG. 1. Each waveplate is characterized by a differential time delay between its fast and slow axis.

Choosing the x and y axis as defined by the linearly polarized (along x, for example) input beam. After propagating through the waveplate system 100, the output electric field will be given by
E(ω)=|E₀(ω)|[\vec{x}a(ω)+\vec{y}b(ω)], 1

where a(ω) and b(ω) are complex coefficients which tell how much phase has been acquired along the respective axis. The “a” and “b” coefficients are wavelength dependent, and they also vary in time in a random fashion. Because of the birefringence, the phase changes are asymmetric, and this leads to the pulse distortion. This is the main cause of signal loss due to polarization mode dispersion PMD.

Given the waveplate model of FIG. 1, if the “x” and “y” axis are considered independently, the phase accumulated in each of them is independent of the other, and spectral and/or power measurements along any or both of these axis will not tell us about the pulse distortion. However, if the electric field along the “x” axis is allowed to interfere with the electric field along the “y” axis, the phase difference between the two electric fields will be seen in the interference pattern. This spectral interference, i.e., the spectrum of the interference term, gives us the spectrum of the phase difference between the two channels, “x” and “y”. An amplitude measurement of the interference term will give us the phase difference, hence the birefringence, between “x” and “y” for every wavelength within the pulse's bandwidth.

To understand how the spectral interference gives us the phase spectrum, consider two orthogonal axis x and y, and two arms of a Mach-Zender interferometer (A and B) as depicted in the schematic 200 in FIG. 2 This interferometer's configuration consists of two beam splitters 203, 213 and two completely reflective mirrors 207, 209. The source beam 201 depicted as a electric field wave “E” 202 with “x” and “y” axis components is split into paths as waves E^{(B)} 204 and E^{(A)} 210.

In one arm the phase along the x-axis is modulated by 211, and in the other one the phase along the y-axis is modulated by 205. The power spectrum is denoted with S(ω). Looking at the combination of the electric fields 214, 215 coming from the two paths A and B of the interferometer, it can be seen that the dispersive difference in phase will lead to a modulation in spectra as follows:
S=S^{(A)}+S^{(B)}+2\sqrt{Sₓ^{(A)}Sₓ^{(B)}} cos(φₓ)−2\sqrt{S_{y}^{(A)}S_{y}^{(B)}} cos(φ_{y}) (2)

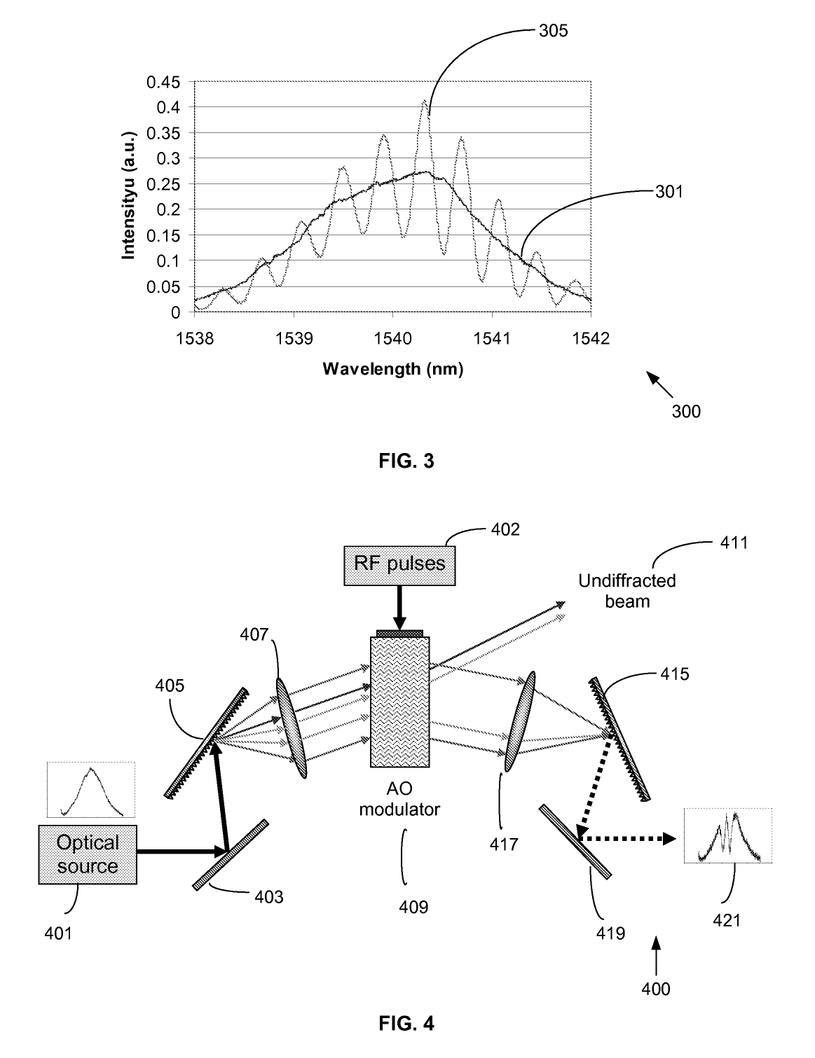

By appropriately choosing the orthogonal axis, one can enhance the interference term in Eq. (2). This can be done, for example, by placing a rotating polarizer before the optical spectrum analyzer. Referring to the graph 300 of FIG. 3, there is shown an example of a spectral interference obtained with a setup similar to that of FIG. 2.

The measured power spectrum shown by line 301 is given by S=S^{(A)+S}^{(B)} which is the case when no phase has been introduced in either arm of the interferometer. As soon as the phase modulators 205, 211 introduce some phase difference between the arms of the interferometer, the spectrum analyzer 216 sees a spectrum that is modulated in frequency, shown by the line 305.

A spectrum of polarization changes can be obtained from the spectral interference a spectrum of polarization changes. An example of inferring polarization mode dispersion PMD from spectral interference has been shown, where the PMD was related to the transmission spectrum measured through an analyzer. There is a simple relationship between the spectral interference and the polarization change, given by:

$$P = \frac{2 \vert \sqrt{{S}_{x}^{( A )} {S}_{x}^{( B )}} cos ( {ϕ}_{x} ( ω ) ) - \sqrt{{S}_{y}^{( A )} {S}_{y}^{( B )}} cos ( {ϕ}_{y} ( ω ) ) \vert}{S} . \qquad ( 3 )$$

Hence, using Eq. (3), one can infer the polarization change as a function of frequency simply by measuring the spectral interference between the two channels, x and y. In other words, by defining two orthogonal axis for the input, and recording the spectrum of the output through a properly placed polarizer, the spectrum of the phase difference between the two axis, i.e., the birefringence spectrum, can be measured. This way, the spectral interference gives us a measure of the polarization change as a function of wavelength, which is really all the information we need to be able to compensate for the PMD. Knowing how much phase has been accumulated at any frequency, allows knowing exactly what the polarization mode dispersion PMD is. Therefore by imposing on the optical pulses a phase opposite to the one measured by spectral interference, we can compensate for the phase accumulated in the fiber and recover the temporal shape which they had before entering the fiber. This can be observed as recovering the spectrum. When the accumulated phase variation is cancelled, the PMD in the transmission fiber is also compensated.

Compensating for the PMD involves solving two steps: one, to measure the phase spectrum as described above; and two, to impose on the optical pulses a phase opposite to the measured one, in order to compensate for the phase accumulated in the fiber.

The inventive technique is to recover the initial pulse through recovering the spectrum. Specifically, the invention imposes on the pulse, before the detector, a phase change to compensate for the phase distortion measured using spectral interference.

After measuring the phase spectrum, i.e., the phase imposed by the propagation through the fiber at every frequency, the next step is the actual compensation. A pulse shaper is used to impose an opposite phase at each frequency. Once the phase introduced by the fiber is cancelled, the pulses will recover the temporal shape they had before entering the fiber.

Pulse shaping is a technique used to change the phase and amplitude of a broadband pulse. The frequency components of the pulse are spatially separated using dispersive elements, and an active component changes the amplitude and/or phase of each frequency component. Liquid crystal arrays and acousto-optic crystals have been used successfully for this task. After this, the frequency components are combined again to form a new pulse, with a phase and amplitude spectrum modified by the active component.

An example 400 of pulse shaping using an acousto-optic modulator (AOM) 409 as the active element to change the phase and amplitude is shown in FIG. 4. An input pulse 401 is directed off a mirror 403 onto a diffraction grating 405 that directs different frequency (wavelength) components of the pulse into different directions and each frequency component is focused at a particular spot in the focal plane of a lens 407. The lens 407 directs the wavelength components to the acousto-optic modulator to diffract and shift the frequency of light according to amplitude/frequency modulated R.F. pulses 402. The modified phase and amplitude spectrum, separated from the undiffracted beam 411, is directed to another lens 417 which focuses the light onto a diffraction grating which directs the combined light off a mirror 419 to provide a shaped pulse 421. Alternative pulse shaping can be liquid crystal, liquid crystal on silicon LCOS or a deformable mirror based, rather than acousto-optic based.

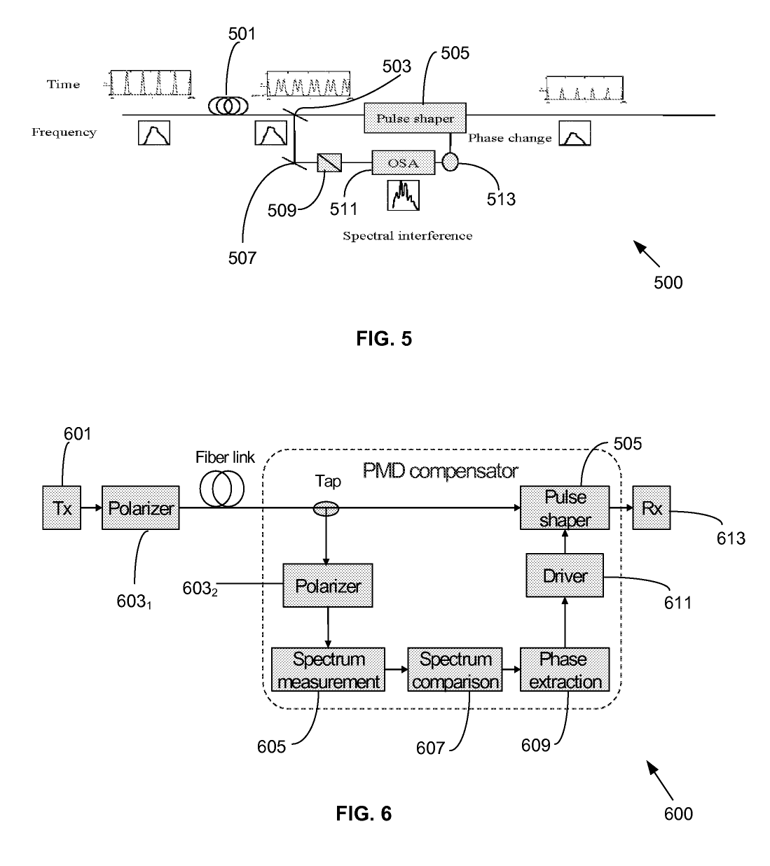

An exemplary embodiment of the inventive method for compensating for PMD is schematically shown 500 in FIG. 5. The pulses acquire unknown phases at each frequency while propagating through a fiber 501, which leads to pulse distortion. Part of the distorted signal is directed by the beam splitter 503 off a mirror 507 through a polarizer 509 to an optical spectrum analyzer (OSA) 511. The optical spectrum analyzer monitors the spectrum through the polarizer 509 rotated to maximize the interference. The spectral interference pattern is transformed into a phase spectrum, which is then imposed with an opposite sign by a tool such as computer 513 onto the signals by the pulse shaper 505. The pulses become short again because the initial undistorted phase spectrum is recovered. This measurement is preferably made on a probe pulse, with a bandwidth encompassing the spectral region required to be compensated for PMD. The pulse could be sent with a frequency permitted by the pulse shaper. For an acousto-optic modulator AOM system, compensation could be done on a microsecond scale, which is well within the requirements for real time PMD compensation. Unlike the inventive real time PMD compensation, prior pulse shaping to compensate for PMD involved compensating for a predetermined (not real time) PMD measured by a broadband polarimeter by using a liquid-crystal based pulse shaper.

An exemplary alternative embodiment of the inventive all-order PMD compensation is schematically shown 600 in FIG. 6. The transmitted pulses 601 are linearly polarized by polarizer 603₁ and they acquire unknown phases at each frequency while propagating through the fiber 605, which leads to pulse distortion. Part of the distorted wave is diverted at a tap through a polarizer 603₂, rotated to maximize the interference, to an optical spectrum analyzer (OSA) that measures the spectral interference 605. The spectral interference pattern is compared with the ideal spectrum at 607 with no PMD. The comparison result is transformed into a phase spectrum 609, passed to a driver 611, which is then imposed with an opposite sign onto the signals by the pulse shaper 505 just before the receiver end 613. In a preferred embodiment, the spectrum comparison 607 and phase extraction 609 are implemented with computer hardware and software.

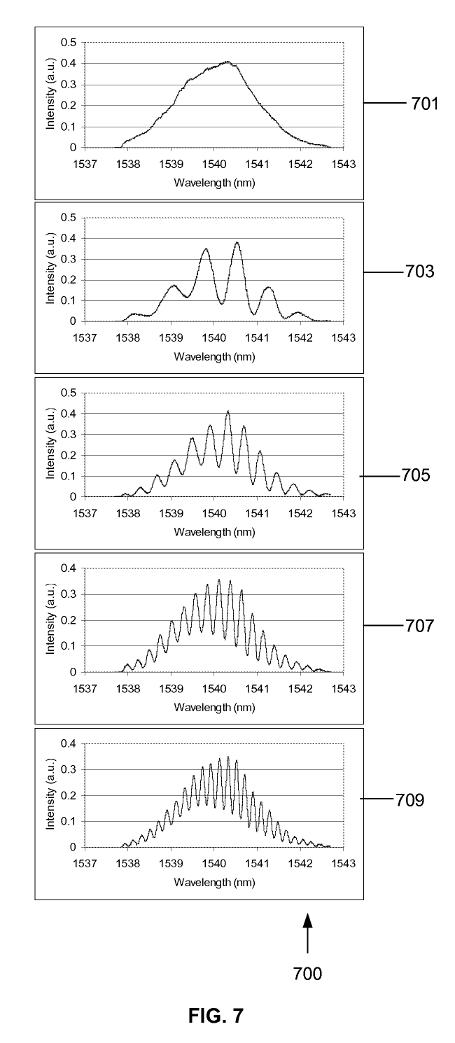

A test system was built using a linearly polarized broadband ASE source at communication wavelength (1.55 μm) as the probing beam. The PMD introduced by a long single mode fiber was simulated by a PMD emulator which can introduce variable linear (first order) PMD. The output of the emulator was sent through an adjustable linear polarizer, and into an optical spectrum analyzer. The PMD delay was varied from 0 to tens of picoseconds and the spectral interference pattern on the spectrum analyzer was monitored. The spectral interference patterns measured for PMD delays from 0, 10, 20, 30 and 40 picoseconds are shown in respective graphs 701, 703, 705, 707 and 709 in the graphs 700 of FIG. 7. A linear relationship between the PMD delay and the fringe pattern was observed. This confirms the fact that the spectral interference is a good measure of the PMD.

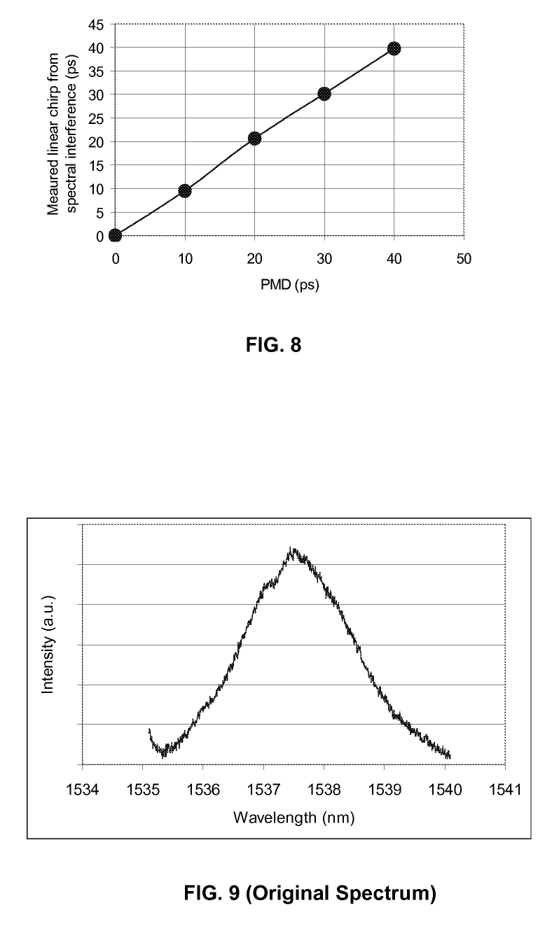

Since the emulator had only first order PMD, the spectral interference was pure sinusoidal and the frequency of the fringes was a direct measurement of the PMD delay. In a real optical transmission line, however, the PMD would be more complex, and the interference pattern would show that accordingly. Once the spectral interference measurement is obtained, extracting the phase spectrum is straightforward. A Fourier program could be used to perform the extraction. The graph of FIG. 8 shows the extracted phase information as a function of the PMD value set by the PMD emulator and confirms a linear relationship between phase and first order PMD. In this case of test PMD emulator the extracted phase information is constant. For real fiber, a complicated phase spectrum would be obtained, and the capability of measuring the real phase spectrum would be limited only by the resolution of the optical spectrum analyzer.

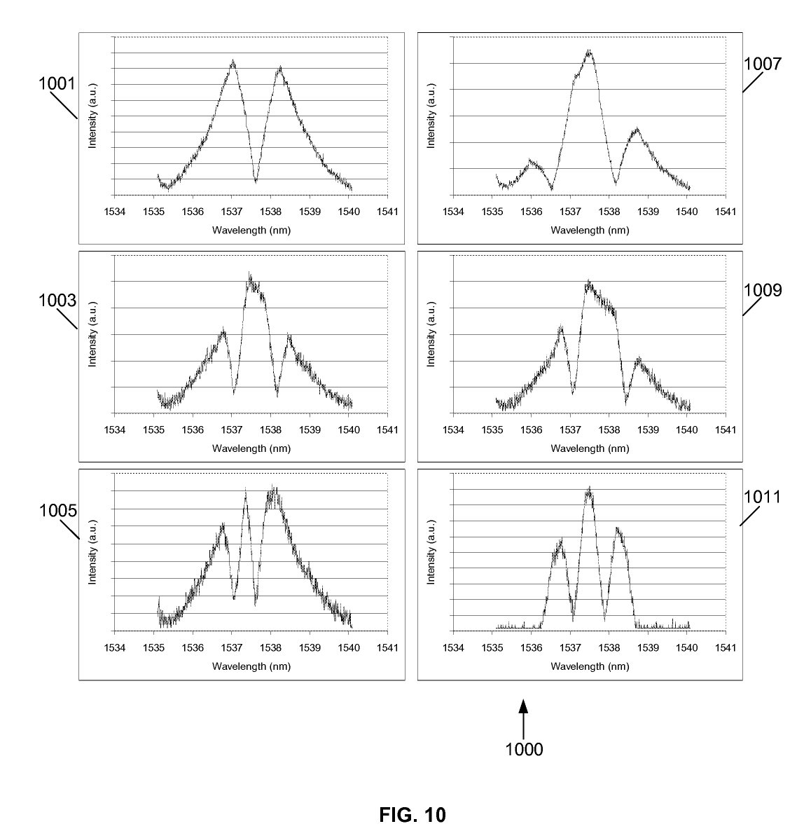

By way of example, an original waveform, see FIG. 9, was subjected to pulse shaping using an acousto-optic modulator (AOM). the graphs 1000 of FIG. 10 depicts sample of waveforms 1001, 1003, 1005, 1007, 1009, 1011 as examples of spectrum manipulation via pulse shaping. The input spectrum, FIG. 9, can be arbitrarily modified by imposing patterns with different periods and depths. For PMD compensation application, the output spectral pattern of the pulse shaper is set to be the opposite of PMD-induced spectral change (similar to FIG. 7). Therefore, combining the PMD extraction element and the pulse shaper, PMD in the optical link can be compensated.

In summary, the invention teaches compensating for PMD to all orders. The invention takes the guess out of the PMD compensation by directly measuring the phase spectrum via spectral interference. The initial measurements demonstrate that spectral interference can be measured and used to determine PMD in a simple system. An acousto-optic based pulse shaper taking into account the spectral interference measured can be used to impose the opposite phase spectrum onto the signal beam, recovering the initial undistorted pulses. The inventive PMD compensation compensate a wide spectrum and therefore is suitable for PMD compensation in a WDM system.

The present invention has been shown and described in what are considered to be the most practical and preferred embodiments. That departures may be made there from and that obvious modifications will be implemented by those skilled in the art. It will be appreciated that those skilled in the art will be able to devise numerous arrangements and variations which, although not explicitly shown or described herein, embody the principles of the invention and are within their spirit and scope.

What is claimed is:

1. A method comprising:
determining spectral interference in real time on an optical signal by an optical path, said spectral interference indicative of polarization mode dispersion by the optical path, and
imposing optical pulses with a phase opposite to the spectral interference on the optical signal.

2. The method of claim 1, wherein said imposing step comprises altering the amplitude or phase of a signal indicative of the spectral interference with an active element.

3. The method of claim 2, wherein said active element is an acousto-optic modulator.

4. The method of claim 1, wherein said imposing step comprises altering the amplitude or phase of each frequency component of a signal indicative of said spectral interference with an active element.

5. The method of claim 1, further comprising the step of recovering said optical signal with a temporal shape before said optical path.

6. The method of claim 1, wherein said step of determining includes extracting a phase spectrum of said spectral interference by the optical path.

7. A method comprising:
compensating for distortion by an optical path on an optical signal by imposing a real time phase spectrum opposing the spectral interference indicative of said distortion by the optical path.

8. The method of claim 7, wherein said distortion is polarization mode dispersion.

9. The method of claim 8, wherein the real time phase spectrum opposing the spectral interference is provided by a pulse shaper employing active amplitude or active phase changing at each frequency component of said spectral interference.

10. The method of claim 9, wherein said active amplitude or active phase changing includes modulation responsive to phase distortion at each frequency component of said distortion based on one of acousto-optic, liquid crystal, liquid crystal on silicon and deformable mirror.

11. An apparatus comprising:
a pulse shaper in an optical path for imposing an opposing optical signal for compensating for distortion by the optical path, and
a feed forward loop for determining phase spectrum of the distortion in real time for influencing said pulse shaper.

12. The apparatus of claim 11, wherein said feed-forward loop is coupled to said optical path by a beam splitter for directing part of an optical signal subjected to said distortion by the optical path.

13. The apparatus of claim 11, wherein said pulse shaper includes an acousto-optic modulator for varying a phase or amplitude of a signal in accordance with the phase spectrum of the distortion.

14. The apparatus of claim 11, wherein said feed-forward loop includes an optical spectrum analyzer for measuring phase spectrum of said distortion.
